(19) United States
(12) Patent Application Publication
(10) Pub. No.: US 2013/0015259 A1
(43) Pub. Date: Jan. 17, 2013

(54) METHOD FOR CHANGING THE RESISTANCE OF A LIQUID AND VESSEL FOR A LIQUID

(71) Applicant: Alexandr Nikolayevich Kurasov, Penza (RU)

(72) Inventor: Alexandr Nikolayevich Kurasov, Penza (RU)

(21) Appl. No.: 13/578,426

(22) PCT Filed: Dec. 29, 2010
(86) PCT No.: PCT/RU2010/000800

§ 371 Date: Sep. 20, 2012

(30) Foreign Application Priority Data
Feb. 16, 2010 (RU) 2010105140

(51) Int. Cl. B05B 9/04

(52) U.S. Cl. 239/11; 239/337

(57) ABSTRACT

A method and a device relate to the area of high-pressure vessels and to the construction of a vessel for a liquid which is under pressure in the process of operation of this vessel, and also a method of changing the hydraulic resistance of the liquid at the outlet from the vessel. This vessel can be for example a system of delivering fuel into a combustion chamber, various presses, including screw extruders in which the material which is being extruded is in the form of a non-Newtonian, i.e. viscoelastic liquid. The method consists in that at the outlet from the vessel (1) an additional tank (2) is mounted which is made in the form of a working chamber of variable volume with one or more discharge openings (3), the volume of the indicated additional tank (2) changing depending on the volume of the liquid which is contained in the working chamber of the additional tank, or depending on the change of the physical parameters of the process or according to a set program. The device of the vessel (1) for a pressurized liquid, which vessel is equipped with an additional tank (2) at the outlet from the vessel which has at least one discharge opening (3) is characterized in that the aforementioned additional tank (2) is made in the form of a chamber of variable volume. The tank (2) consists of a stationary element (6) which is connected directly to the vessel (1) for the liquid, an element (7) which can move in the axial direction with one or more discharge openings (3) and which connects these elements of a hollow, predominantly cylindrical element (8) which has a movable connection at least to one of the aforementioned elements (6) and (7) of the tank (2). The automatic or semiautomatic control elements for the volume of the tank (2) are labeled item 9.

The inventions (method and device) relate to the area of high-pressure vessels and to the construction of a vessel for a liquid which is under pressure in the process of operation of this vessel, and also a method of changing the hydraulic resistance of the liquid at the outlet from the vessel. This vessel can be for example a system of delivering fuel into a combustion chamber, various presses, including screw extruders in which the material which is being extruded is in the form of a non-Newtonian, i.e. viscoelastic liquid. The task of this method and device consists in actively controlling the process of flow of the liquid out of the vessel under pressure, without changing the geometrical characteristics of the discharge opening, but changing only the hydraulic resistance to the flow of the liquid which is passing through this device.

### METHOD

The patent literature discloses a method of regulating the force of resistance of a hydraulic damper in the suspension of a means of transport (see patent RF No. 2127675 for cl. F16F9/48, 1999). The method consists in that besides changing the flow section of the channel which links the cavities of the damper depending on the pressure difference between these cavities, the motion of the piston of the damper is converted into displacement of a part of the damper whose position influences the size of the flow section of the channel. The method solves the problem of automatically changing the resistance characteristic of the damper within wide limits depending on the amplitude of irregularities of the roadway coating.

The method of actively changing the hydraulic resistance of a liquid at the outlet from a vessel for pressurized liquid as such has not been found in the examined volume of sources of information. With respect to the hydraulic resistance as a phenomenon which exists in any hydraulic system, it is generally known that it increases as the number of obstacles found in the flow path of the liquid increases. The obstacles to liquid flow are formed by the alternation of volumes and the openings which connect them. Usually the presence of these obstacles is recognized as a defect of the hydraulic system, therefore efforts are made to eliminate them (see, for example, the method of reducing the hydraulic resistance according to RF patent No. 2168108, cl. F17D 1/16, 2000). The proposed method is based on the intentional creation of obstacles on the liquid flow path and the use of this procedure at the outlet from the vessel to achieve a positive effect in terms of controlling the hydraulic pressure; in particular this is of current interest for substances which have properties which change. At low pressure, even at relatively high temperature they are hard and cannot be processed using methods of casting or thermoplastic extrusion under pressure. Difficulties of simply raising the pressure in the delivery vessel under pressure is caused by the complexity of manufacture and operation of very fine equipment of very strong materials which cannot be operated without high-speed wear, including for reasons of thermal deformations and high friction. This leads to the impossibility of manufacturing products in a sufficient amount and to their overly high net cost. Here the demands on raw material, workers and the state of equipment are very high. Even minor wear leads to unserviceability of equipment since it does not ensure working parameters. In particular the manufacture of plastic masses with a high melting point, or the injection of fuel into a combustion chamber of engines require very precise manufacture of parts and materials of high strength. A major problem, especially in the pumping of substances which change their phase from solid to liquid under the action of pressure, is the first instant of discharge of a liquid which has not yet been plasticized under the action of pressure. At this instant the discharge of a not yet liquid, but solid, however friable mass is only possible at relatively low resistance of the outlet. But with the gradual increase of plasticity a solid body begins to be transformed into a liquid and for continuing the process an increase of the pressure and a corresponding change of the hydraulic resistance at the outlet are required.

Therefore a simple and economical method of increasing and changing the pressure for a liquid flowing out of a vessel under pressure is of great current interest both economically and also technologically. This will make it possible to manufacture equipment with less precision and from cheaper materials and to lengthen periods of its operation by several times, fine-tuning the pressure which is necessary for operation by changing the hydraulic resistance for the outflowing liquid.

The technical result of the invention (method) is the possibility of manufacturing equipment which is designed for implementing this method with less precision and from cheaper materials, and of lengthening periods of its operation by several times, fine-tuning the pressure which is necessary for operation by changing the hydraulic resistance for the outflowing liquid.

This technical result is achieved in that in the proposed method of actively changing the hydraulic resistance of a liquid at the outlet from a vessel for a pressurized liquid, at the outlet from the vessel an additional tank is mounted which is made in the form of a working chamber of variable volume with one or more discharge openings, the volume of the indicated additional tank being changed depending on the volume of the liquid contained in the working chamber of the additional tank, or depending on the change of the physical parameters of the process, or in accordance with a set program. Here the volume of the indicated additional tank is changed for example using a movable partition which is mounted in it and which is moved in the axial direction.

### VESSEL

A vessel for a pressurized liquid is known which is equipped with an additional tank at the outlet from the vessel which has at least one discharge opening (see for example RF No. 2172115, cl. B 29 C 47/30, 2001). This vessel is the housing of an extruder which is equipped with an additional tank at its outlet. The defect of this vessel is that the aforementioned additional tank at its output has a constant volume. For this reason major problems arise especially in working with substances which according to the technological process should pass from the solid into the liquid phase under the action of high pressure. At the first instant the discharge of this substance from the vessel in the form of a friable mass which is not yet plasticized is only possible at a relatively low resistance (pressure) at the outlet. But as the plasticity gradually increases, when the solid begins to be converted into a liquid, an increase of resistance (pressure) at the outlet is required to continue the process.

Let us examine this defect in greater detail using the example of an extruder. In this case the vessel for the pressurized liquid will be the housing of the extruder which is filled with the extrudate.

According to this patent the additional tank at the outlet from the extruder housing is as if one stabilizing the pressure and flow rate of the product. But during startup and in the working mode the following takes place. When the mass travels into the first additional tank and also into the second and following additional tanks (if they are present), at the first instant in conjunction with the sudden pressure drop at the extruder outlet (since the additional tanks are empty at the instant) a sudden drop of plasticity of the mass takes place. The latter, sometimes becoming too hard, clogs the outlet opening of the draw plate, stopping the process which has just begun. The greater the volume of the additional tank, the greater the probability of clogging, and beginning with a certain volume, startup in principle becomes impossible. Working with two, three additional tanks along the axis of the extruder is also almost impossible. But even after successful startup another problem arises: since the volume of the additional tank is fixed, fine-tuning of its hydraulic resistance for creating optimum extrusion conditions in the steady-state mode is impossible. More often a shortage of this volume during the steady state process is observed since low resistance was required during startup and it is insufficient in the steady-state mode.

The technical result of this invention (vessel) is the possibility of smoothly changing the hydraulic resistance for a liquid (true or elasto-plastic) which is flowing under pressure out of the opening of the vessel by smoothly changing the volume of the additional tank (additional tanks).

This technical result is achieved in that in the vessel for the pressurized liquid which is equipped with an additional tank at the outlet from the vessel which has at least one discharge opening, the aforementioned additional tank is made in the form of a chamber of variable volume. Here the aforementioned additional tank at the outlet from the cavity of the vessel can be made compound, consisting of a stationary element which is connected directly to the vessel for the liquid, an element which can move in the axial direction with one or more discharge openings and which connects these elements of a hollow, predominantly cylindrical element which has a movable connection at least to one of the aforementioned elements of the additional tank, the aforementioned elements being telescopically interconnected. At the outlet from the cavity of the vessel the aforementioned additional tank can also be made compound, consisting of a stationary element which is connected directly to the vessel for the liquid, an element which can move in the axial direction with one or more discharge openings which are made in the movable partition which is mounted in this element, and which element connects these elements of a hollow, predominantly cylindrical element which can move in the axial direction and which has a movable connection to each of the aforementioned elements of the additional tank and which is equipped with a movable partition with one or more passage openings, the aforementioned elements being telescopically interconnected.

Another of the modifications of the claimed vessel for a pressurized liquid is one in which the aforementioned additional tank at the outlet from the cavity of the vessel is made compound, consisting of a stationary element which is connected directly to the vessel, or an element which can move in the axial direction and which has been inserted into a socket at the outlet from the cavity of the vessel, with one or more passage openings, and a following element which can move in the axial direction with one or more discharge openings and which interacts with the aforementioned stationary or the aforementioned movable element, the aforementioned elements being telescopically interconnected; at least one other element which can be moved in the axial direction with one or more discharge openings can be connected to the very last element.

A further modification of the claimed vessel for a pressurized liquid is one in which the aforementioned additional tank at the outlet from the cavity of the vessel is made compound, consisting of a movable or stationary element which is connected directly to the vessel for the liquid, an element which can move in the axial direction with one or more discharge openings and which connects these elements of a hollow, predominantly cylindrical element which can move in the axial direction and which has a movable connection to each of the aforementioned elements of the additional tank, these elements being telescopically interconnected; at least one other element which can be moved in the axial direction with one or more discharge openings can be connected to the very last element. This modification of the claimed vessel calls for extending the compound tank theoretically “to infinity”.

Finally, a modification of the vessel for a pressurized liquid is possible in which the aforementioned additional tank at the outlet from the cavity of the vessel is made compound, consisting of a movable or stationary element which is connected directly to the vessel for the liquid, an element which can move in the axial direction with one or more passage openings, these elements being telescopically interconnected; at least one other element which can be moved in the axial direction with one or more discharge openings can be connected telescopically or using a cylindrical element to the very last element.

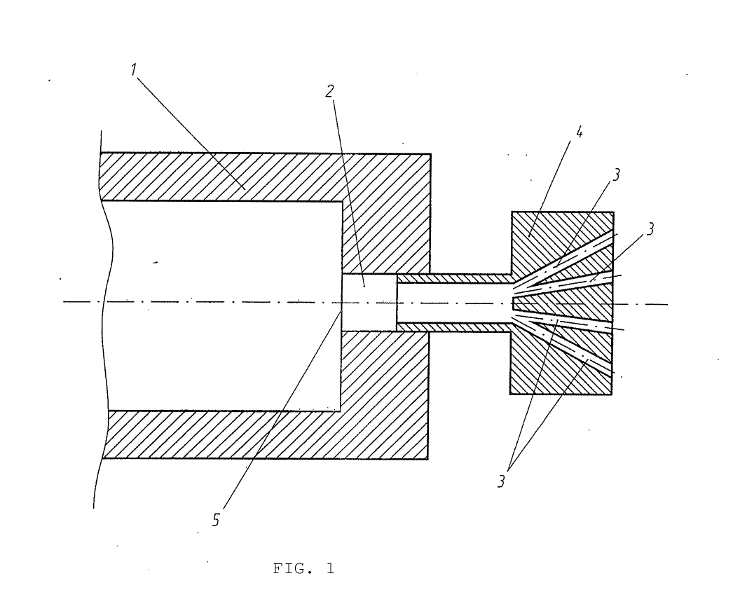

FIG. 1 shows a longitudinal section of the simplest modification of a vessel for a pressurized liquid with an arbitrary number of discharge openings.

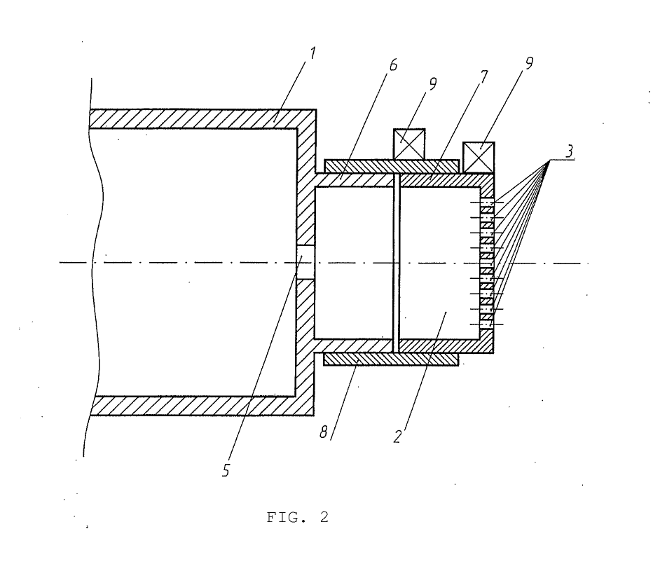

FIG. 2 shows a longitudinal section of a vessel for a pressurized liquid, with an additional tank which has an element which can move in the axial direction and automatic and semiautomatic control elements, with external positioning of the connecting element.

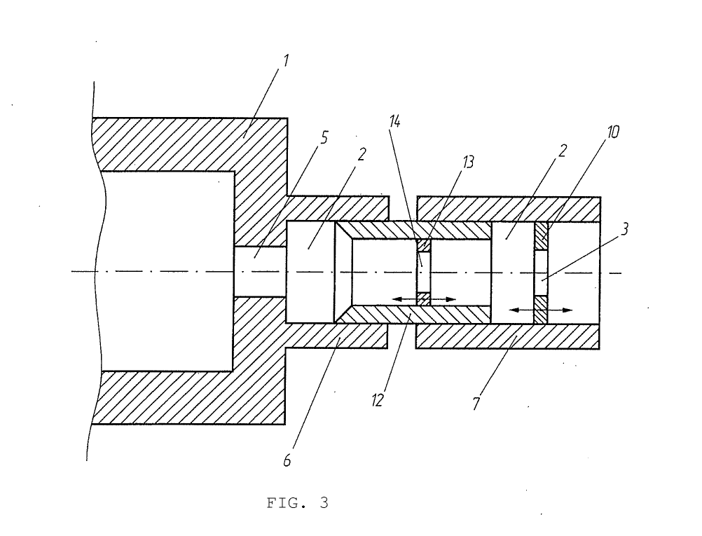

FIG. 3 shows a longitudinal section of a vessel for a pressurized liquid with internal positioning of the connecting element.

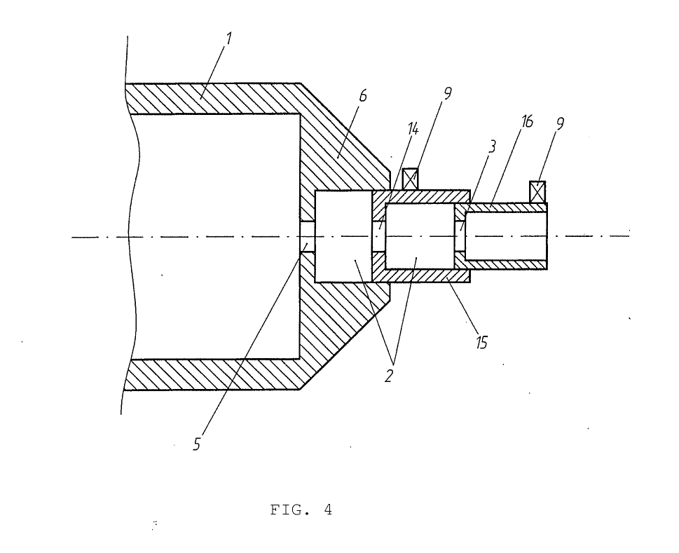

FIG. 4 shows a longitudinal section of a vessel for a pressurized liquid with an additional tank which is equipped with a partition.

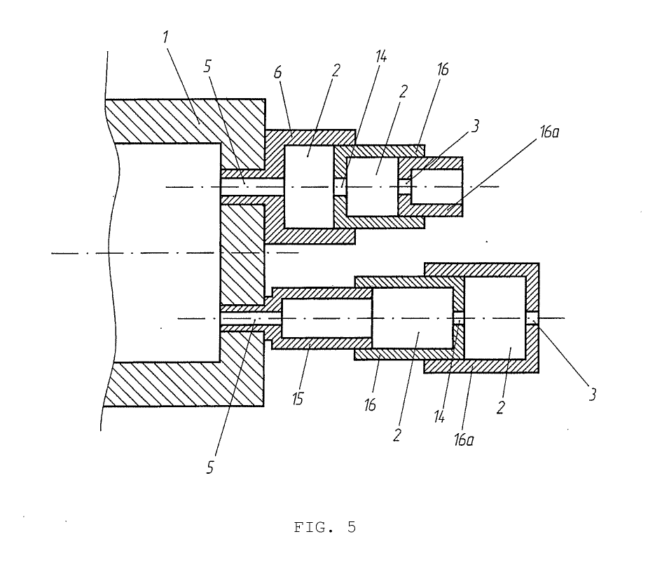

FIG. 5 shows a longitudinal section of a modification of the claimed vessel which calls for extension of the additional tank theoretically “to infinity”.

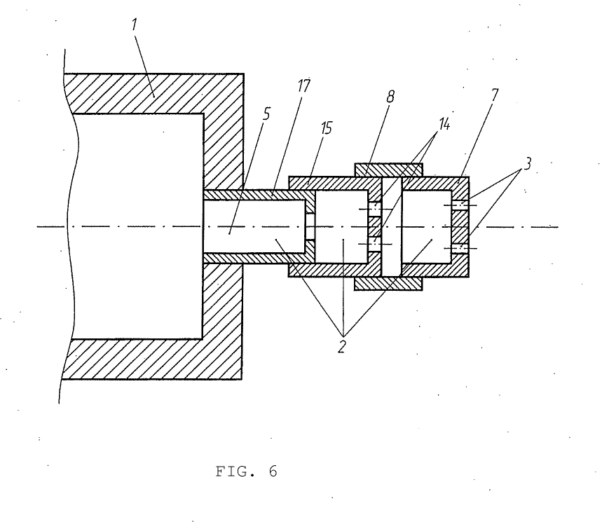

FIG. 6 shows a longitudinal section of a modification of the claimed vessel in which all elements of the additional tank can move mutually.

The claimed method of actively changing the hydraulic resistance of the liquid at the outlet from the vessel for a pressurized liquid is carried out using the vessel for a pressurized liquid which is also the invention, described below.

Thus, FIG. 1 schematically shows the schematic structure of the claimed vessel according to which the vessel 1 for the pressurized liquid is equipped with an additional tank 2. The additional tank 2 is equipped at least with one discharge opening 3 made in the assembly 4, and is located at the outlet 5 from the vessel. FIG. 1 shows a modification of the claimed vessel with several outlet openings.

According to the object of the invention the aforementioned additional tank 2 is made in the form of a chamber whose volume can be changed by axial displacement of the assembly 4 relative to the vessel 1.

FIGS. 2-6 show possible construction versions of the claimed vessel for a pressurized liquid which develop the above described schematic construction of the claimed vessel for a liquid, which is shown in FIG. 1, in various directions. These versions are characterized in that in each of them the aforementioned additional tank 2 which is located at the outlet 5 from the cavity of the vessel 1 is made compound.

Thus, in the construction shown in FIG. 2 the aforementioned additional tank 2 consists of a stationary element 6 which is connected directly to the vessel 1 for the liquid, an element 7 which can move in the axial direction with one or more discharge openings 3 and which connects these elements of a hollow, predominantly cylindrical element 8 which has a movable connection at least to one of the aforementioned elements 6 and 7 of the additional tank 2. The automatic or semiautomatic control elements for the volume of the tank 2 are labeled item 9.

In the construction shown in FIG. 3, the aforementioned additional tank 2 consists of a stationary element 6 which is connected directly to the vessel 1, an element 7 which can move in the axial direction with one or more discharge openings 3 which are made in the movable partition 10 which is mounted in this element, and which element connects these elements of a hollow, predominantly cylindrical element 12 which can move in the axial direction, which has a movable connection to each of the aforementioned elements of the additional tank and which is equipped with a movable partition 13 with one or more passage openings 14. The aforementioned elements are telescopically interconnected.

In the construction shown in FIGS. 4 and 5 the additional tank 2 is made consisting of a stationary element 6 which is connected directly to the vessel 1, or an element 15 which can move in the axial direction and which has been inserted into a socket at the outlet from the cavity of the vessel 1, with one or more passage openings 14, and a following element 16 which can move in the axial direction with one or more discharge openings 3 and which interacts with the aforementioned stationary 6 or aforementioned movable element 15, the aforementioned elements 6, 15 and 16 being telescopically interconnected. FIG. 5 shows the construction of the claimed vessel 1 for a liquid, which vessel can have several (in this case two) outlets 5 accordingly with several (in this case two) compound additional tanks 2. Here at least one other element 7 which can move in the axial direction with one or more discharge openings 3 can be connected to the very last movable element (16 in FIG. 4 or 16a in FIG. 5) telescopically or using a cylindrical element 8 or 12 (see FIG. 2 or 3).

In the construction shown in FIG. 6, the additional tank 2 consists of a movable or stationary element 17 which is connected directly to the vessel 1 for a liquid, and an element 15 which can move in the axial direction with one or more passage openings 14. The elements 15 and 17 are telescopically interconnected. Here at least one other element 7 which can move in the axial direction with one or more discharge openings 3 can be connected to the last element 17 telescopically or using a cylindrical element 8.

Let us examine the practical use of the claimed vessel for a pressurized liquid using the example of operation of an extruder. As indicated above, in this case the vessel for the pressurized liquid will be the housing of an extruder which is filled with an extrudate.

Before the start of the extrusion process (see for example FIG. 2) the volume of the additional tank 2 at the outlet 5 of the extruder (vessel 1) can be minimized after having moved the movable element 7 up against the stationary element 6 and if there are movable partitions 10 and 13 (see FIG. 3) they can also be moved for minimizing their effect on the hydraulic resistance of the additional tank 2. After the liquid which is being extruded (extrudate) begins to emerge stably from the drawing die (discharge openings 3 of the additional tank 2) for achieving the necessary physical parameters of the process of outflow of the liquid (extrusion process) by changing the hydraulic resistance of the additional tank 2, the movable element 7 is moved away from the stationary element 6 to the right. Thus, the change of the hydraulic resistance in the system is achieved by changing the length and accordingly the volume of the additional tank 2 between the housing of the extruder (vessel 1) with an opening for discharge 5 and the drawing die (discharge openings 3), and also if necessary by moving the partitions 10 and 13 within the additional tank 2 (see FIG. 3).

As follows from the aforementioned description of the claimed vessel for a pressurized liquid, the claimed method of actively changing the hydraulic resistance of the liquid at the outlet from the vessel 1 for the pressurized liquid (see, for example FIG. 2) consists in that at the outlet 5 from the vessel 1 an additional tank 2 is mounted which is made in the form of a working chamber of variable volume with one or more discharge openings 3. Here the volume of the indicated additional tank 2 is changed depending on the volume of the liquid which is contained in the working chamber of the additional tank 2, or depending on the change of the physical parameters of the process or according to a set program (it is not disclosed in this application).

In addition, according to the claimed method of actively changing the hydraulic resistance of the liquid at the outlet from the vessel 1 for a pressurized liquid (see for example FIG. 3), the volume of this additional tank 2 can be changed using the movable partition 10 and (or) 13 which is mounted in it and which is moved in the axial direction.

Examples of the claimed method as applied to the process of extrusion are cited below.

### Example 1

Before startup of the extruder the drawing element (movable element 7) is moved as near as possible to the housing of the extruder (vessel 1). In this position the hydraulic pressure at the outlet 5 of the vessel 1 is minimum. The extruder is started up. After the physical parameters and discharge of the extrudate begin to stabilize and the danger of interruption of the flow of the extrudate passing through the drawing plates (discharge openings 3) disappears, it becomes possible to more exactly adjust the pressure in the extruder (vessel 1) by changing the distance, and thus the volume of the additional tank 2 (and as a result—changing the hydraulic resistance) without changing the other parameters of the extruder (vessel 1) and of the technological process.

### Example 2

After startup and stabilization of the technological process, the distance which is maximum for a given construction between the housing of the extruder (vessel 1) and the drawing element (movable element 7) is established; the pressure in the extruder (vessel 1) has increased, but not enough. The decision is made to move the partitions 10 and 13 (one or both) in the direction to the outlet 5 of the extruder (vessel 1). This action increases the hydraulic resistance of the system and increases the pressure and temperature in the extruder (vessel 1) without changing other parameters.

### Example 3

In the extrusion process the properties of the material have changed, it has become more plastic, and the pressure and the temperature had to be reduced. Accordingly the length of the additional tank 2 can be reduced or if the partitions 10 and 13 are set, they can be shifted to reduce their effect on the hydraulic resistance.

The physical sense of the method and the device consists in the possibility of smoothly changing the hydraulic resistance for the pressurized liquid (true or elastoplastic) flowing out of the opening of the vessel. The change of the hydraulic resistance during the outflow process, in particular its increase when the volume of the additional tank (tanks) and their number increase, leads to an increase in the pressure in the system consisting of the vessel—tanks, i.e. the friction in the liquid and the liquid with the device, and consequently, the temperature. A reduction of the volumes and their number leads to a decrease of the pressure and consequently of the friction in the system, and thus of the temperature. Here it is not necessary to change the other physical parameters of the device, including the operating parameters of the drive; this is very convenient and cheap since it can change the operating conditions of the system smoothly and if necessary depending on the state, in particular, the wear of the equipment. The change of the pressure and temperature in the system when the volumes of the additional tanks change is not of an absolute, but a relative nature and depends largely on the characteristics of the liquid. The less the liquid is a true liquid and the more it has elastoplastic properties, the stronger the effect of increasing the volumes and their number. The change of the pressure can be up to 1000%, and the change of the temperature up to 500% compared to a vessel without additional tanks.

Here in the extrusion process it is possible to change the internal volume of the additional tanks 2 within a factor of 1.5-2, or for other constructions up to a factor of 1000, essentially from a zero value to 2000 ml. Thus the process can be started on a minimum volume (FIG. 2); this guarantees starting and its normal conditions—speed, cleanliness, absence of equipment overloads, and as the parameters of the process are established the optimum volume of the additional tanks can be found.

This method and this device as applied to the process of extrusion also make it possible to process material on a large area of the drawing plates or for larger numbers of them (i.e. when the area of the drawing plates is increased) without pressure loss in the extruder, thus intensifying the production process and increasing the productivity of the equipment.

Sources of information taken into account:
RU 2127675, F16F9/48, 1999;
RU2168108, cl. F17D1/16, 2000;
RU 2172115, cl. B 29 C 47/30, 2001 (prototype).

1. A method of actively changing the hydraulic resistance of a liquid at the outlet from a vessel for a pressurized liquid, characterized in that at the outlet from the vessel an additional tank is mounted which is made in the form of a working chamber of variable volume with one or more discharge openings, the volume of the indicated additional tank being changed depending on the volume of the liquid contained in the working chamber of the additional tank, or depending on the change of the physical parameters of the process, or in accordance with a set program.

2. The method as claimed in claim 1, wherein the volume of the indicated additional tank is changed using a movable partition which is mounted in it and which is moved in the axial direction.

3. A vessel for a pressurized liquid, which is equipped with an additional tank at the outlet from the vessel which has at least one discharge opening, wherein the aforementioned additional tank is made in the form of a chamber of variable volume.

4. The vessel for a liquid as claimed in claim 3, wherein the aforementioned additional tank at the outlet from the cavity of the vessel is made compound, consisting of a stationary element which is connected directly to the vessel for the liquid, an element which can move in the axial direction with one or more discharge openings and which connects these elements of a hollow, predominantly cylindrical element which has a movable connection at least to one of the aforementioned elements of the additional tank, the aforementioned elements being telescopically interconnected.

5. The vessel for a liquid as claimed in claim 3, wherein the aforementioned additional tank at the outlet from the cavity of the vessel is made compound, consisting of a stationary element which is connected directly to the vessel for the liquid, an element which can move in the axial direction with one or more discharge openings which are made in the movable partition which is mounted in this element, and which element connects these elements of a hollow, predominantly cylindrical element which can move in the axial direction and which has a movable connection to each of the aforementioned elements of the additional tank and which is equipped with a movable partition with one or more passage openings, the aforementioned elements being telescopically interconnected.

6. The vessel for a liquid as claimed in claim 3, wherein its additional tank at the outlet from the cavity of the vessel is made compound, consisting of a stationary element which is connected directly to the vessel, or an element which can move in the axial direction and which has been inserted into a socket at the outlet from the cavity of the vessel, with one or more passage openings, and a following element which can move in the axial direction with one or more discharge openings and which interacts with the aforementioned stationary or the aforementioned movable element, the aforementioned elements being telescopically interconnected, and at least one other element which can be moved in the axial direction with one or more discharge openings can be connected to the very last element.

7. The vessel for a liquid as claimed in claim 3, wherein the aforementioned additional tank at the outlet from the cavity of the vessel is made compound, consisting of a movable or stationary element which is connected directly to the vessel for the liquid, an element which can move in the axial direction with one or more discharge openings and which connects these elements of a hollow, predominantly cylindrical element which can move in the axial direction and which has a movable connection to each of the aforementioned elements of the additional tank, these elements being telescopically interconnected, and at least one other element which can be moved in the axial direction with one or more discharge openings can be connected to the very last element.
The vessel for a liquid as claimed in claim 3, wherein the aforementioned additional tank at the outlet from the cavity of the vessel is made compound, consisting of a movable or stationary element which is connected directly to the vessel for the liquid, an element which can move in the axial direction with one or more passage openings, these elements being telescopically interconnected, and at least one other element which can be moved in the axial direction with one or more discharge openings can be connected telescopically or using a cylindrical element to the very last element.
